(19) United States
(12) Patent Application Publication
(10) Pub. No.: US 2011/0238776 A1
(43) Pub. Date: Sep. 29, 2011

(54) METHOD AND SYSTEM FOR THE VIRTUALIZED STORAGE OF A DIGITAL DATA SET

(75) Inventors: Dominique Vinay, Clamart (FR); Loic Lambert, Le Tour du Parc (FR); Philippe Motet, Igny (FR)

(73) Assignee: ACTIVE CIRCLE, Vannes (FR)

(21) Appl. No.: 13/128,576

(22) PCT Filed: Nov. 10, 2009
(86) PCT No.: PCT/FR2009/052157

§ 371 Date: May 10, 2011

(30) Foreign Application Priority Data
Nov. 10, 2008 (FR) 0806251

(51) Int. Cl. G06F 15/167

(52) U.S. Cl. 709/213

(57) ABSTRACT

This method of virtualized storage of a digital data set (40) in a computing system comprising several interconnected hardware storage resources (50₁, 50_{2,} 50₃, 52₁, 52₂, 54₁, 54₂, 54₃, 54₄) comprises the generation of a set of virtual storage spaces of first level (50, 52, 54), in which each virtual space is associated with part of the hardware storage resources and with characteristic parameters.

It comprises the following steps: creation of a virtual storage space of second level (44) associated with a service class (46) parameterized as a function of storage constraints (42) for the data set (40) and assignment of this virtual storage space (44) to the data set (40); selection of at least one virtual storage space of first level (50, 52, 54) by comparing the service class (46) of the virtual storage space of second level with the characteristic parameters of each virtual storage space of first level; storage of the data set (40) in the hardware resources associated with the virtual storage space of first level selected.

The present invention relates to a method of virtualized storage of a digital data set in a computing system comprising several network interconnected hardware storage resources.

More specifically, the invention relates to a method of virtualized storage comprising the generation of a set of virtual storage spaces, in which each virtual storage space is associated with part of the hardware storage resources and with characteristic parameters linked to said part of hardware storage resources.

Such a method is for example described in the international patent application published under the number WO 2006/077215. In this document, when a set of data has to be stored in the considered network of hardware storage resources, a module of assignment of virtual disk able to reserve a virtual space begins by selecting part of the resources as a function of their performance compared with constraints formulated in a storage request, then creates a virtual disk dedicated to the data set and associated with this part of the selected resources. According to this method, as many virtual disks are generated as sets of data to be stored and the distribution of the data of a set in the hardware storage resources is managed by the corresponding virtual disk, as a function of what has been assigned to it as resources by the assignment module.

This method works well on a static network, but has limited flexibility when the network evolves through the addition, deletion, failure or replacement of hardware resources. For example, in the event of failure of a hardware storage resource, the data stored by this resource must be moved and the virtual disks associated with this data, which can come from several data sets, must be redefined.

It may thus be desired to provide a method of virtualized storage that enables these problems and constraints to be overcome.

An object of the invention is thus a method of virtualized storage of a digital data set in a computing system comprising several network interconnected hardware storage resources, comprising the generation of a set of virtual storage spaces of first level, in which each virtual storage space of first level is associated with part of the hardware storage resources and with characteristic parameters linked to this part of the hardware storage resources, characterised in that it comprises the following steps:
creation of a virtual storage space of second level associated with a service class parameterized as a function of storage constraints of the data set and assignment of this virtual storage space of second level to the data set,
selection of at least one virtual storage space of first level by comparing the service class of the virtual storage space of second level with the characteristic parameters of each virtual storage space of first level, and
storage of the data set in the hardware resources associated with the virtual storage space of first level selected.

Thus, thanks to the presence of two levels of virtual storage spaces, it is possible to make virtual storage of the data set independent of the management of the hardware storage resources. Indeed, the hardware resources are associated with virtual spaces of first level which are thus concerned by additions, deletions, failures or replacements of resources. On the other hand, the virtual spaces assigned to the sets of data to be stored or stored are of a second level and their resources are virtual spaces of first level. They thus have no direct visibility on the hardware storage resources, which makes the method more flexible in the case of evolution of the network comprising these resources.

In an optional manner, the virtual storage spaces of first level are designed to store data packets of predetermined common size, and a step is provided of transformation of the data set into one or more packets of said predetermined common size as a function of the global size of the data set.

This makes it possible to de-correlate a little further the virtual storage spaces of first level, and thus the resources, from the nature and the size of the data set to be stored.

Also in an optional manner, the transformation of the data set into one or more packets comprises the following steps:
splitting the data set into several sub-sets,
compression and/or encryption of the data of each sub-set, and
addition of a heading to each compressed and encrypted sub-set to form a packet of said predetermined common size.

Also in an optional manner, the storage step comprising a distribution of the data set in the hardware resources associated with the virtual storage space of first level selected, the method of virtualized storage according to the invention further comprises a step of memorisation of this distribution in relation with the virtual storage space of second level created.

Also in an optional manner, the digital data set is a digital file or a digital data stream.

Also in an optional manner, each virtual storage space of first level is associated with part of the hardware storage resources using a unique storage technology chosen from the components of the set constituted of a storage technology by hard disk and a storage technology by magnetic tape.

Another object of the invention is a computer programme downloadable from a communication network and/or stored on a support readable by computer and/or executable by a processor, characterised in that it comprises programme encoding instructions for the execution of the steps of a method of virtualized storage as defined previously when said programme is executed on a computer.

Another object of the invention is a virtualized storage system of a digital data set, comprising several network interconnected hardware storage resources, means for generating a set of virtual storage spaces of first level in which each virtual storage space of first level is associated with part of the hardware storage resources and with characteristic parameters linked to said part of the hardware storage resources, characterised in that it further comprises:
means for creating a virtual storage space of second level associated with a service class parameterized as a function of storage constraints of the data set and for assignment of this virtual storage space of second level to the data set,
means for selecting at least one virtual storage space of first level by comparing the service class of the virtual storage space of second level with the characteristic parameters of each virtual storage space of first level, and
means for storing the data set in the hardware resources associated with the virtual storage space of first level selected.

In an optional manner, a virtualized storage system according to the invention comprises several network interconnected storage servers, each storage server being moreover connected locally to part of the hardware storage resources and comprising said means for generating a set of virtual storage spaces of first level, said means for creating a virtual storage space of second level, said means of selection and said means of storage.

In this case, the virtualized storage service can be ensured from several servers of a distributed system.

Also in an optional manner, the virtual storage spaces of first and second levels being conserved in memory in the form of description data distributed between the storage servers and replicated on several servers for at least part of them, it comprises means for synchronizing, between the storage servers, actions acting on said description data.

The invention will be better understood on reading the description that follows, given uniquely by way of example and by referring to the appended drawings in which:

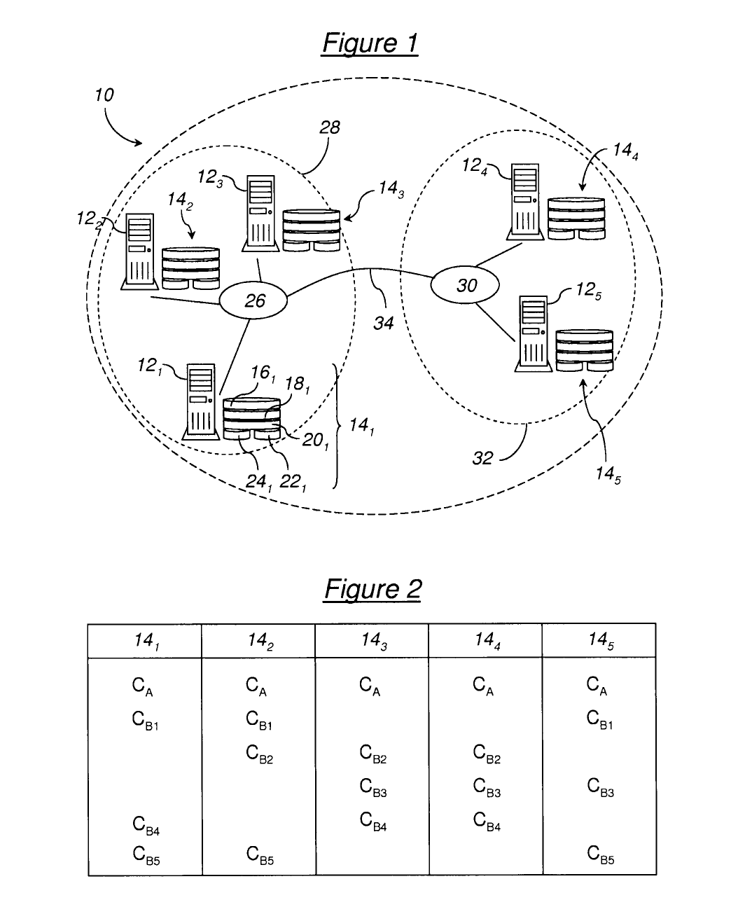

FIG. 1 schematically represents the general structure of an example of computing system for storage of data distributed in several network interconnected servers,

FIG. 2 illustrates an example of distribution of description data in the storage computing system of FIG. 1,

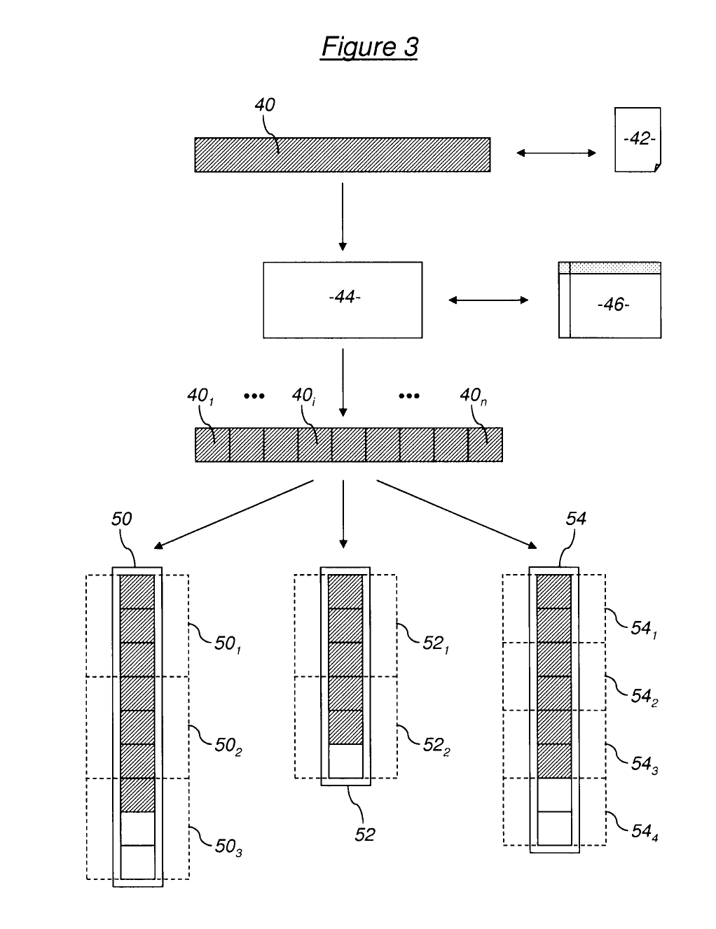

FIG. 3 schematically represents the structure of a set of virtual storage spaces with two levels generated for the application of a method of virtualized storage according to the invention, and

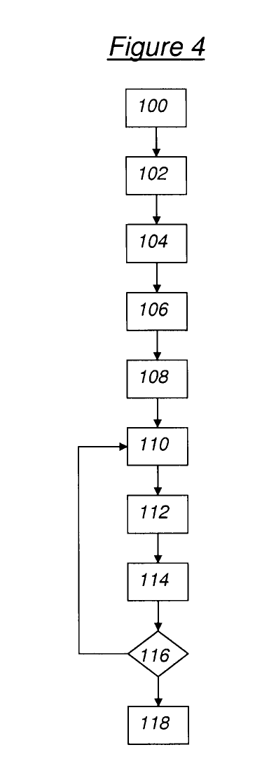

FIG. 4 illustrates the successive steps of a method of virtualized storage according to an embodiment of the invention.

The computing system 10 represented in FIG. 1 comprises several servers 12₁, 12₂, 12₃, 12₄ and 12₅ equipped with hardware storage resources. These servers are distributed over several domains or geographic sites. Each server is of conventional type and will not be detailed. Its storage resources are for example connected locally in the form of peripherals or internal hard disks. In an example of service management distributed architecture, at least one specific software and hardware module 14₁, 14₂, 14₃, 14₄ and 14₅ for management of a data storage service is installed on each server 12₁, 12₂, 12₃, 12₄ and 12₅.

Five storage servers and two domains are represented in FIG. 1 purely by way of illustration, but any other structure of computing system with network interconnected hardware storage resources could be suited for the implementation of a method of virtualized storage according to the invention. In particular, although the example illustrated in this figure concerns a storage system distributed between several storage servers all a priori able to manage the data storage service, the latter could also, in an alternative manner and in another example of architecture, be managed in a centralised manner by a single server having access to all of the hardware storage resources locally or remotely.

Also for reasons of simplification, one software and hardware module per server is represented, such that the modules and their respective servers could be merged in the remainder of the description, without however having to be merged in a more general implementation of the invention.

The software and hardware module 14₁ of the storage server 12₁ is detailed in FIG. 1. It comprises a first software layer 16₁ constituted of an operating system of the server 12₁. It comprises a second software layer 18₁ for management of description data of the data storage service provided by the computing system 10. It comprises a third software and hardware layer 20₁ fulfilling at least two functions: a first function of storage, on an internal hard disk of the server 12₁, of the description data of the storage service and a second cache memory function, also on this hard disk, of data stored on hardware storage resources connected to the server 12₁. Finally, it comprises a fourth software and hardware layer 22₁, 24₁ of warehouses of data of first level, comprising at least one warehouse of data on hard disk 22₁ and/or at least one warehouse of data on magnetic tapes 24₁. For the remainder of the description, a warehouse of data of first level designates a virtual storage space of data constituted of one or more partitions of one or more hard disks, or of one or more storage devices on magnetic tapes, among the hardware storage resources of the server with which it is associated.

The software and hardware modules 14₂, 14₃, 14₄ and 14₅ of the servers 12₂, 12₃, 12₄ and 12₅ will not be detailed because they are similar to the software and hardware module 14₁.

In the example illustrated in FIG. 1, the servers 12₁, 12₂ and 12₃ are mutually interconnected by a first LAN type network 26 to create a first sub-set or domain 28. This first domain 28 corresponds for example to a localised geographic organisation, such as a geographic site, a building or a computer room. The servers 12₄ and 12₅ are mutually interconnected by a second LAN type network 30 to create a second sub-set or domain 32. This second domain 28 also corresponds for example to another localised geographic organisation, such as a geographic site, a building or a computer room. These two domains are connected together by a WAN type network 34, such as the Internet network.

Thus, this computing system of cluster of servers distributed on several geographic sites makes it possible to envisage storage of data all the more sure since said data can be replicated on software and hardware modules situated on different geographic sites.

The storage service provided by this computing system 10, comprising especially the virtual storage spaces generated to fulfil this service, and the data actually stored are advantageously completely defined and described by a set of description data that will be presented in their general principles with reference to FIG. 2. That way, the management of these description data by the software layer 18ᵢ of any of the software and hardware modules 14ᵢ ensures management of the storage service of the computing system 10.

The description data are for example grouped together into several sets structured according to their nature and if appropriate connected together. A structured set, which will be called “catalogue” in the remainder of the description, may be in the form of an arborescence of directories themselves containing other directories and/or description data files. The representation of the description data according to an arborescence of directories and files comprises the advantage of being simple and thus economic to design and manage. In addition, this representation is often sufficient for the targeted service. It is also possible, for more complex applications, to represent and manage the description in relational data bases.

A catalogue of description data may be global, in other words concern description data useful for the whole of the computing system 10, or instead local, in other words concern description data specific to one or more software and hardware modules 14₁, 14₂, 14₃, 14₄ or 14₅ for management of the service. Advantageously, each catalogue is replicated on several servers or software and hardware modules. When it is global, it is preferably replicated on the whole set of software and hardware modules. When it is local, it is replicated on a predetermined number of software and hardware modules, of which at least that or those that it concerns.

By way of example, FIG. 2 represents a possible distribution of catalogues of description data between the five software and hardware modules 14₁, 14₂, 14₃, 14₄ and 14₅.

A first global catalogue C_{A} is replicated on the five software and hardware modules 14₁, 14₂, 14₃, 14₄ and 14₅. It comprises for example data describing the general infrastructure and the general operation of the computing system 10 for the provision of the storage service, especially the arborescence of the domains and software and hardware modules of the computing system 10. It can also comprise data describing potential users of the data storage service and their access rights, for example users enrolled beforehand, as well as the zones for sharing, the structure or the mode of storage and the replication of data stored.

Other catalogues are local, such as for example the catalogue C_{B1}, containing description data specific to the software and hardware module 14, such as the local infrastructure and the local operation of the server 12, and of its hardware storage resources, or the organisation into warehouses of first level of the software and hardware module 14₁. This catalogue is replicated in three copies, one of which is on the software and hardware module 14₁. To improve the security and the robustness of the computing system 10, the catalogue C_{B1} may be replicated in several different domains. Here, the complete system comprising two domains 28 and 32, the catalogue C_{B1} is for example saved on the modules 14₁ and 14₂ of the domain 28 and on the module 14₅ of the domain 32.

Similarly, the software and hardware modules 14₂, 14₃, 14₄ and 14₅ are associated with local catalogues respectively C_{B2}, C_{B3}, C_{B4} and C_{B5}. For example, the catalogue C_{B2} is saved on the modules 14₂ and 14₃ of the domain 28 and on the module 14₄ of the domain 32; the catalogue C_{B3} is saved on the module 14₃ of the domain 28 and on the modules 14₄ and 14₅ of the domain 32; the catalogue C_{B4} is saved on the module 14₄ of the domain 32 and on the modules 14₁ and 14₃ of the domain 28; and the catalogue C_{B5} is saved on the module 14₅ of the domain 32 and on the modules 14₁ and 14₂ of the domain 28.

The aforementioned list of catalogues of description data is not exhaustive and is only given by way of example, as is the number of replications of each catalogue.

By this replication of catalogues, here on at least three software and hardware modules for each catalogue, it will be noted that even if one software and hardware module, or even two, is (are) out of operation, the system as a whole is capable of accessing the whole set of description data such that the management of the data storage service is not necessarily interrupted.

In practice, this continuity of maintained service is efficient from the moment where a synchronization of catalogues is ensured.

To do this, the software layer of each software and hardware module of the computing system 10 comprises for example:
means for emitting a synchronization message, identifying an action acting on a description data, to the whole set of other software modules of the computing system comprising a replication of this description data, following the execution of this action on said software module, and
means of executing an action acting on a description data and identified in a synchronization message, so as to act on the replication of the description data situated on said software module, in response to the reception of a synchronization message coming from another software module.

It will be noted on the other hand that such synchronization, as well as the replication of catalogues described previously, are not necessary in the case where the management of the storage service is centralised on a single server.

Among the description data that may be distributed in data catalogues, according to the invention, warehouses of data of first and second levels are defined.

As indicated previously, the warehouses of first level are defined in the fourth software and hardware layer of each storage server 12₁, 12₂, 12₃, 12₄ and 12₅. They are each associated with part of the hardware storage resources of the computing system 10. More specifically, they are each associated with at least part of the hardware storage resources of the storage server on which they are generated. In particular, in FIG. 1, at least one first storage warehouse of first level is for example defined in the software part of the fourth software and hardware layer 22₁ of the server 12₁, in association with hardware storage resources constituted of one or more external hard disks. At least one second storage warehouse of first level is for example defined in the software part of the fourth software and hardware layer 24₁ of the server 12₁, in association with hardware storage resources constituted of one or more storage devices on magnetic tapes.

Each warehouse of first level is moreover associated with a service class reassuming the characteristic parameters linked to the hardware storage resources of this warehouse. Preferably, each warehouse of first level is to this end associated with hardware resources using a unique storage technology, in other words in practice either a storage technology by hard disk, or a storage technology by magnetic tape.

The characteristic parameters of a warehouse of first level thus comprise for example the choice of a storage technology, parameters of access time to the data stored, storage capacity, accessibility of the different hardware resources thereof, cost per octet of an elementary storage space, localisation of the hardware resources, etc. In other words, the characteristic parameters of a warehouse of first level comprise performance parameters (for example the data access time), but also more generally other characteristics (for example the localisation, the technology, the cost per octet) enabling storage constraints and/or functionalities to be better taken into account.

It is clearly apparent that a storage technology has an impact on the service class of a warehouse of first level: a warehouse using a storage technology by magnetic tape thus has specific characteristics, such as the possibility of easily moving data stored off site, the facility of increasing its capacity, good storage performance, but a longer access to the data.

Furthermore, by application of the properties of catalogues formulated previously, certain warehouses of first level are local, others are global. For example, it may be established that a local warehouse is based on a server in particular (that which is equipped with hardware storage resources with which this warehouse is associated) and is only accessible from this server. This may be for example agreed from the moment where a certain technology is used, such as storage technology on hard disk. It may be established on the other hand that a global warehouse is accessible from several storage servers of the computing system 10. In this case, such a warehouse of first level is represented in several servers and the service class with which it is associated is the same whatever the access server. From the moment where a storage device by magnetic tapes is accessible from any server, if there is a compatible reader, any warehouse using this storage technology may be considered as global.

In an optional manner, the warehouses of first level may be designed to store data packets of common size, according to a predetermined storage granularity. These data packets may moreover be optimised and secured by being compressed and encrypted according to a requisite level of service. A warehouse of first level, of which ever it is, may then be seen as containing several containers of fixed size each able to receive a data packet.

In conclusion, the whole set of warehouses of first level represents the storage capacity offered by the computing system 10, this capacity being able to evolve as additions, deletions, replacements, modifications of hardware storage resources are made.

According to the invention, warehouses of second level are defined as virtual storage spaces of data sets. Each warehouse of second level is thus assigned to a particular data set, whether this set is a digital file or a digital data stream to be stored. It is for example dynamically created, during the reception of a storage request of this data set.

Consequently, a set of warehouses of second level represents at each instant a storage request of data sets applying to the computing system 10.

The warehouses of second level are for example defined in the second software layer 18ᵢ for management of description data of the servers 12ᵢ. In the same way as the warehouses of first level, they may be defined in a local or global manner. On the other hand, they are not associated with any hardware storage resource of the computing system 10. Their potential resources are the warehouses of first level that they are able to select as a function of their characteristic parameters.

Each warehouse of second level is moreover associated with a service class defined as a function of storage constraints and functionalities relative to the corresponding data set. For example, these storage constraints and functionalities may be in part formulated in a storage request of the corresponding data set. These constraints are more particularly conditions to meet and may be linked to a start date and an end date. The functionalities are additional services proposed by the warehouse, such as compression, encryption, date and time recording, electronic signature, use of antivirus in reading, complete deletion of data during freeing of memory space, etc.

The service class of a warehouse of second level thus defines for example:
a number of copies of the data set that must be stored,
any constraints concerning a localisation of the warehouses of first level to select,
the designation a priori of one or more warehouses of first level in particular,
any constraints concerning the type of storage technology to use,
a required level of security,
a first duration for which a first type of storage is required, a second duration for which a second type of storage is required, etc.,
a duration beyond which the data set may be deleted and the corresponding storage space freed,
a sequence of processings to apply to the data set (aforementioned functionalities), at the moment of storage or later,
etc.

Advantageously, when a warehouse of second level is created for the storage of a data set, the computing system 10 is designed to ensure regularly, or instead permanently, that the associated service class, parameterized as a function of the storage constraints of this data set, is indeed respected. Indeed, if the service class is modified, if a warehouse of first level selected for the storage of at least part of the data set is deleted or if the characteristics thereof change, the computing system 10 may be brought to modify the selection of warehouses of first level for this warehouse of second level, so that the characteristic parameters of the warehouses of first level selected are at each instant compatible with the constraints and functionalities required by the service class of the warehouse of second level.

FIG. 3 illustrates the structure and the operation of a set of virtual storage spaces with two levels such as those described previously for the implementation of a method of virtualized storage of digital data.

In this figure, a data set 40, for example a digital file or a binary data stream, is associated with information 42 on storage constraints. These storage constraints may be gathered together in the form of a file, a request. They may also exist implicitly, by default or according to a context.

A warehouse of second level 44 is created to manage the storage of the data set 40. It fulfils the function of virtual storage space directly assigned to the set 40. It is associated, as indicated previously, with a service class 46, being in the form of one or more files, parameterized especially as a function of the storage constraints 42.

A constraint may for example be in the following form: “conserve three copies, of which one on hard disk on the Paris site for five weeks”. In this case, this constraint entails the service class 46 by a start date (that of the storage of the set of data in the resources of the computing system 10), an end date (the start date+five weeks), a number of copies that have to be stored established at three and a geographic domain imposed for one of the copies (the hardware storage resources of the Paris site).

Another constraint may for example specify the preceding constraint in the following manner: “conserve a copy in RAID 5 type resources on disks on the Paris site for five weeks, conserve a copy in RAID 5 type resources on disks on the Vannes site for five weeks, conserve two copies on magnetic tapes for ten years”. This precision signifies that, the data set being intended to be consulted often for the first five weeks but less often subsequently, a rapid but expensive storage and limited in volume for five weeks is favoured, to then transfer it onto magnetic tapes for ten years. After ten years, the data will be deleted and the storage space freed, unless this has been done before by a specific request of the owner of this data set.

Many other constraints may be imagined. They are each time translated into parameters in the service class 46.

In an optional manner, the warehouses of first level are designed to store data packets of predetermined common size. In this case, the data set 40 is transformed into one or more packets 40₁, . . . , 40ᵢ, . . . , 40ₙ of this same size. The number of packets obtained thus depends on this predetermined common size.

The transformation of the data set 40 into one or more packets 40₁, . . . , 40ᵢ, . . . , 40ₙ, comprises for example the following steps:
splitting of the data set 40 into several sub-sets,
compression and encryption of the data of each sub-set, and
addition of a heading to each compressed and encrypted sub-set to form a packet of the predetermined common size.

To store the packets 40₁, . . . , 40ᵢ, . . . , 40ₙ obtained, and according to the constraints and functionalities parameterized in the class of data 46, warehouses of first level 50, 52 and 54 are selected as a function of their characteristic parameters.

It will be noted that to verify the constraints and functionalities parameterized in the class of data 46, several selection methods, especially sequential, may be imagined by those skilled in the art and will thus not be detailed. By way of example, if among the constraints a duplication of the data is required on two very particular distant sites and that during the selection a warehouse of first level localised on the first site is already determined at a given instant, the selection will then only be interested in the warehouses of first level localised on the second site and finally choose a warehouse of first level of the second site meeting a maximum of the remaining constraints.

Three selected warehouses of first level are represented in FIG. 3, in a purely illustrative and non limiting manner.

A first selected warehouse 50 of first level is for example associated with three hardware storage resources 50₁, 50₂ and 50₃ of same type and of uniform characteristics. These are for example three external hard disks, three partitions of a same hard disk, etc. Each of these resources comprises storage containers able to receive packets. Three per resource are represented for the warehouse 50, for reasons of simplification. In reality, the number of containers per resource is much greater.

A second selected warehouse 52 of first level is for example associated with two hardware storage resources 52₁ and 52₂ of same type and of uniform characteristics. Each of these resources also comprises storage containers able to receive packets. Three per resource are represented for the warehouse 52.

Finally, a third selected warehouse 54 of first level is for example associated with four hardware storage resources 54₁, 54₂, 54₃ and 54₄ of same type and of uniform characteristics. Each of these resources also comprises storage containers able to receive packets. Two per resource are represented for the warehouse 54.

The packets 40₁, . . . , 40ᵢ, . . . , 40ₙ are then distributed (in one or more copies depending on the storage constraints) in the hardware storage resources of the selected warehouses 50, 52 and 54 as a function of parameters of the service class 46. This distribution is conserved in memory in relation with the warehouse of second level 44 created.

By means for example of the infrastructure illustrated in FIG. 1 and thanks to the structure in two levels of virtual storage spaces illustrated in FIG. 3, a method of virtualized storage such as that illustrated in FIG. 4 may be implemented.

During a first step 100, which may be executed at any moment, from the conception of the computing system 10 to any modification of its infrastructure through the addition, deletion, replacement or modification of any server or any hardware storage resource, a set of virtual spaces of first level, in other words the set of warehouses of first level, is created or modified. As a function of the hardware storage resources assigned to each of these warehouses of first level, characteristic parameters such as those defined previously are also assigned to them during this step.

During a step 102, a data set to be stored, for example the set 40, is received by the computing system 10, via one of its servers 12₂, 12₃, 12₄ or 12₅.

Then, at a step 104, a virtual storage space of second level, as it happens the warehouse of second level 44, is created. Its service class 46 is parameterized as a function especially of the storage constraints 42 of the data set 40. It is assigned to the management of the storage of the data set 40.

At the following optional step 106, the data set 40 is transformed into sub-sets of same size.

Then, during a step 108, also optional, each of these sub-sets is compressed and encrypted, then a heading is added to each compressed and encrypted sub-set to form a packet of predetermined size. The packets 40₁, . . . , 40ᵢ, . . . , 40ₙ are thereby obtained.

During a selection step 110, among the existing set of warehouses of first level, certain (50, 52 and 54) are selected as a function of their accessibility from the server having received the data set 40 but also by comparing the service class 46 of the warehouse of second level 44 with the characteristic parameters of each virtual storage space of first level.

At the following step 112, the packets 40₁, 40ᵢ, . . . , 40ₙ are distributed in the hardware resources associated with the warehouses of first level selected 50, 52 and 54.

Then, during a step 114, the distribution of packets in the different hardware storage resources associated with the selected warehouses of first level 50, 52 and 54 is conserved in memory in relation with the warehouse of second level 44.

The following step 116 is a step of waiting for events capable of modifying the distribution of the packets stored and relative to the data set 40. These events comprise especially a modification of parameters of the service class 46, an action provided in the service class 46, a change of characteristic parameters of one of the selected warehouses of first level, the addition, deletion or modification of a warehouse of first level, etc.

If one of these events occurs, one then returns to step 110 to perform a new distribution of data packets 40₁, . . . , 40ᵢ, . . . , 40ₙ. If not, one passes to a final step 118 of end of storage of the data set 40, when the storage duration defined in the service class 46 expires. During this final step, the data packets 40₁, . . . , 40ᵢ, . . . , 40ₙ are deleted and the corresponding memory space is freed.

It is clearly apparent that a method and/or system as described previously enables a better flexibility in the case of evolution of the storage resources. Indeed, a first level of virtual storage spaces manages the hardware storage resources whereas a second level, having for resources the virtual storage spaces of the first level, manages the virtualized storage of the data sets. Thus, it is possible to make the virtual storage of data sets independent of the management of the hardware storage resources. The infrastructure of the storage computing system 10 may thus evolve without disrupting the virtualized storage service.

For example, if a warehouse of first level loses a hard disk following a breakdown, it can indicate it by an alarm for all of the data packets concerned. The warehouses of second level concerned will then be assigned a new selection of warehouses of first level for a new distribution of the data packets, without the data set being assigned a new warehouse of second level. The latter lasts for the whole contractual duration of the storage.

In the event of obsolescence of a hardware storage resource linked to a warehouse of first level, it is possible to add a new more efficient hardware resource, to recopy the packets stored in the obsolete resource to the new resource, then to reference the data packets on this new resource. All of this is carried out in total transparency for the warehouses of second level having this warehouse of first level as resource. This concerns in particular the hardware storage resources on magnetic tapes.

During a change of storage technology, it suffices to declare a new warehouse of first level exploiting the new technology. When storage renewals of data sets are required or programmed for data of which certain packets are stored in a warehouse concerned by this change of technology, these packets are recopied in the new warehouse. The former warehouse can be deleted when all of the packets that it contains have been moved or deleted. It is also possible to modify the service classes of the warehouses of second level concerned so that the packets intended initially to be stored in the former warehouse are stored in the new warehouse. Thus, the change of storage technology takes place in a simple and reliable manner.

It should be noted moreover that the previously described method of virtualized storage is not incompatible with a storage service enabling the archiving of data according to a standard format such as the TAR (Tape ARchiver) format. Indeed, the service class of a data set that has to be archived according to this format may indicate it such that a distribution in data packets on different resources is not performed, or is performed in addition to this archiving.

Finally, it will be noted that the invention is not limited to the embodiment described previously. Indeed, it has been presented in an architecture distributed in several servers able to provide a same service of virtualized storage, then necessitating a synchronization between said servers. But it could also be implemented in a centralized architecture and would then no longer be subject to these synchronization constraints.

1. Method of virtualized storage of a digital data set (40) in a computing system comprising several network interconnected hardware storage resources (50₁, 50₂, 50₃, 52₁, 52₂, 54₁, 54₂, 54₃, 54₄), comprising the generation (100) of a set of virtual storage spaces of first level (50, 52, 54), in which each virtual storage space of first level is associated with part of the hardware storage resources and with characteristic parameters linked to this part of the hardware storage resources, characterised in that it comprises the following steps:
creation (104) of a virtual storage space of second level (44) associated with a service class (46) parameterized as a function of storage constraints (42) for the data set (40) and assignment of this virtual storage space of second level (44) to the data set (40),
selection (110) of at least one virtual storage space of first level (50, 52, 54) by comparing the service class (46) of the virtual storage space of second level (44) with the characteristic parameters of each virtual storage space of first level, and
storage (112) of the data set (40) in the hardware resources associated with the virtual storage space of first level selected (50, 52, 54).

2. Method of virtualized storage according to claim 1, wherein the virtual storage spaces of first level (50, 52, 54) are designed to store data packets of predetermined common size, and in which is provided a step (106, 108) of transformation of the data set (40) into one or more packets (40₁, . . . , 40ᵢ, . . . , 40ₙ) of said predetermined common size as a function of the global size of the data set.

3. Method of virtualized storage according to claim 2, wherein the transformation (106, 108) of the data set into one or more packets (40₁, . . . , 40ᵢ, . . . , 40ₙ) comprises the following steps:
splitting (106) the data set into several sub-sets,
compression and/or encryption (108) of the data of each sub-set, and
addition (108) of a heading to each compressed and encrypted sub-set to form a packet of said predetermined common size.

4. Method of virtualized storage according to any of claims 1 to 3, wherein, the storage step (112) comprising a distribution of the data set (40) in the hardware resources (50₁, 50₂, 50₃, 52₁, 52₂, 54₁, 54₂, 54₃, 54₄) associated with the virtual storage space of first level selected (50, 52, 54), it further comprises a step (114) of memorisation of this distribution in relation with the virtual storage space of second level created (44).

5. Method of virtualized storage according to any of claims 1 to 4, wherein the digital data set (40) is a digital file or a digital data stream.

6. Method of virtualized storage according to any of claims 1 to 5, wherein each virtual storage space of first level (50, 52, 54) is associated with part of the hardware storage resources (50₁, 50₂, 50₃, 52₁, 52₂, 54₁, 54₂, 54₃, 54₄) using a unique storage technology chosen from the components of the set constituted of a storage technology by hard disk (22₁) and a storage technology by magnetic tape (24₁).

7. Computer programme downloadable from a communication network and/or stored on a support readable by computer and/or executable by a processor, characterised in that it comprises programme encoding instructions for the execution of the steps of a method of virtualized storage according to any of claims 1 to 6 when said programme is executed on a computer.

8. System (10) of virtualized storage of a digital data set (40), comprising several network interconnected (26, 30, 34) hardware storage resources (50₁, 50₂, 50₃, 52₁, 52₂, 54₁, 54₂, 54₃, 54₄), means (14₁, 14₂, 14₃, 14₄, 14₅) for generating a set of virtual storage spaces of first level (50, 52, 54) in which each virtual storage space of first level is associated with part of the hardware storage resources and with characteristic parameters linked to said part of the hardware storage resources, characterised in that it further comprises:
means (14₁, 14₂, 14₃, 14₄, 14₅) for creating a virtual storage space of second level (44) associated with a service class (46) parameterized as a function of storage constraints (42) of the data set (40) and for assignment of this virtual storage space of second level (44) to the data set (40),
means (14₁, 14₂, 14₃, 14₄, 14₅) for selecting at least one virtual storage space of first level (50, 52, 54) by comparing the service class (46) of the virtual storage space of second level (44) with the characteristic parameters of each virtual storage space of first level, and
means (14₁, 14₂, 14₃, 14₄, 14₅) for storing the data set in the hardware resources associated with the virtual storage space of first level selected (50, 52, 54).

9. Virtualized storage system (10) according to claim 8, comprising several network interconnected (26, 30, 34) storage servers (12₁, 12₂, 12₃, 12₄, 12₅), each storage server (12₁, 12₂, 12₃, 12₄, 12₅) being moreover connected locally to part of the hardware storage resources (22₁, 24₁) and comprising said means for generating a set of virtual storage spaces of first level, said means for creating a virtual storage space of second level, said means of selection and said means of storage.

10. Virtualized storage system (10) according to claim 9, wherein, the virtual storage spaces of first (50, 52, 54) and second (44) levels being conserved in memory in the form of description data distributed between the storage servers (12₁, 12₂, 12₃, 12₄, 12₅) and replicated on several servers for at least part of them, it comprises means (14₁, 14₂, 14₃, 14₄, 14₅) for synchronizing, between the storage servers, actions acting on said description data.
